(19) United States
(12) Patent Application Publication
(10) Pub. No.: US 2026/0167137 A1
(43) Pub. Date: Jun. 18, 2026

(54) REAR RAIL HITCH INTERFACE FOR A VEHICLE

(71) Applicant: FCA US LLC, Auburn Hills, MI (US)

(72) Inventors: Ramachandra Bhat, Auburn Hills, MI (US); Abhishek Paul, Auburn Hills, MI (US); Nitin Sharma, Auburn Hills, MI (US)

(21) Appl. No.: 18/981,986

(22) Filed: Dec. 16, 2024

(51) Int. Cl. B60R 19/24; B60D 1/56

(52) U.S. Cl. CPC B60R 19/24; B60D 1/56

(57) ABSTRACT

A bumper interface assembly for a vehicle includes a bumper cross-member, a bumper mounting bracket extending from the bumper cross-member and a frame member receiving the bumper mounting bracket. A reinforcement member is coupled directly to and within the bumper mounting bracket and disposed between the bumper mounting bracket and the frame member.

### FIELD

The present disclosure relates to a hitch for a vehicle, and, more specifically, to a rear frame rail hitch interface.

### BACKGROUND

This section provides background information related to the present disclosure which is not necessarily prior art.

For various trucks and sport utility vehicles, a significant load is generated at the rear rail hitch during trailering. The bumper is coupled to the frame of the vehicle at a rail interface. The rail interface needs some type of reinforcement to support various loads. While supporting loads, the interface is also required to be crushable for rear crash advents while maintaining strength to carry the loads from the trailer hitch. Internal combustion engine vehicles also require exhaust hangers. Exhaust hangers may change the integrity of the interface.

### SUMMARY

This section provides a general summary of the disclosure and is not a comprehensive disclosure of its full scope or all of its features.

The present system for joining frame rail and bumper to allow desired crash performance together with strength performance.

In one aspect of the disclosure, a bumper interface assembly for a vehicle includes a bumper cross-member, a bumper mounting bracket extending from the bumper cross-member and a frame member receiving the bumper mounting bracket. A reinforcement member is coupled directly to and within the bumper mounting bracket and disposed between the bumper mounting bracket and the frame member.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a partial perspective view of a rear portion of a vehicle.

FIG. 1B is an enlarged perspective view of the bumper interface assembly of the present disclosure.

FIG. 2A is a perspective view of one example of a bumper mounting bracket.

FIG. 2B is a perspective view of a second example of a bumper mounting bracket.

FIG. 2C is a perspective view of the bumper interface assembly from above the vehicle looking downward.

FIG. 2D is a cross-sectional view of the bumper interface assembly.

FIG. 3A is a first perspective view of a rail having the reinforcement member therein.

FIG. 3B is a second perspective view of the rail having the reinforcement member therein.

FIG. 3C is a third perspective view of the rail having the reinforcement member therein.

FIG. 3D is a perspective view of the reinforcement member.

Corresponding reference numerals indicate corresponding parts throughout the several views of the drawings.

### DETAILED DESCRIPTION

Example embodiments will now be described more fully with reference to the accompanying drawings.

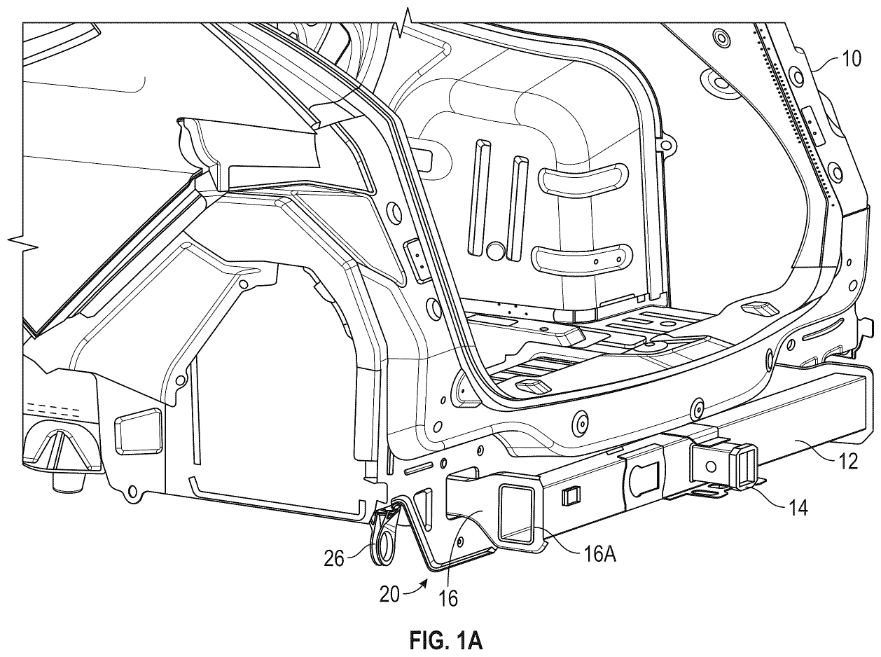

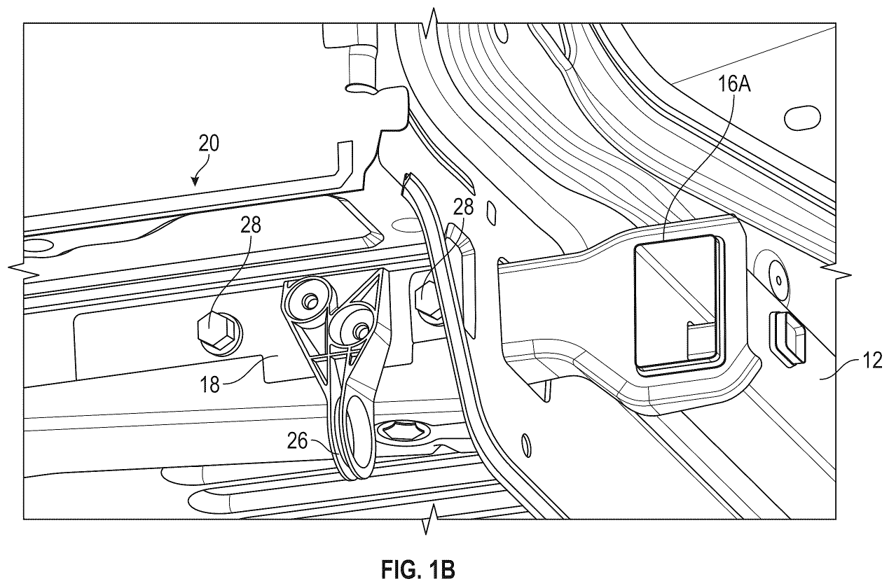

Referring now to FIG. 1A, a rear portion of a vehicle 10 is illustrated. In this example, the vehicle 10 is a sport utility vehicle. However, the vehicle 10 may be any type of vehicle including, but not limited to, a sport utility vehicle, a pick-up truck, a van, a station wagon, a coupe or a sedan. The vehicle 10 may be an electric vehicle or an internal combustion engine vehicle. While a rear portion of a vehicle 10 is illustrated, the present disclosure may be used in the front of the vehicle 10.

A bumper cross-member 12 has a hitch 14 extending therefrom. The hitch 14 may also be referred to as a hitch receiver. The hitch 14 receives a ball that is used for trailering. Of course, the hitch 14 may be used for other purposes including coupling various racks, such as bike rack, a luggage rack, a watercraft rack or the like. The hitch 14 may be welded or integrally formed with the bumper cross-member 12.

Referring now also FIG. 1B, a bumper mounting bracket 16 is used for coupling the bumper cross-member 12 to the vehicle frame comprising frame members such as a frame rail 18 of the vehicle 10. Two bumper mounting brackets 16 are used on either end of the bumper cross-member for coupling to the vehicle frame rail 18. In the present example, the bumper mounting bracket 16 has an opening 16A that is sized to receive the bumper cross-member 12.

A bumper interface assembly 20 is formed by the intersection of the bumper mounting bracket 16, the rail 18 and a reinforcement member as described in greater detail below. In FIG. 1B, the rail 18 is used to support an exhaust hanger 26. The exhaust hanger 26 is used in an internal combustion engine vehicle. However, the exhaust hanger 26 is not present in an electric vehicle. The bumper interface assembly 20 is coupled together using fasteners 28. The fasteners 28 extend laterally relative to the vehicle 10 and extend through the bumper interface assembly 20 as will be described in greater detail below.

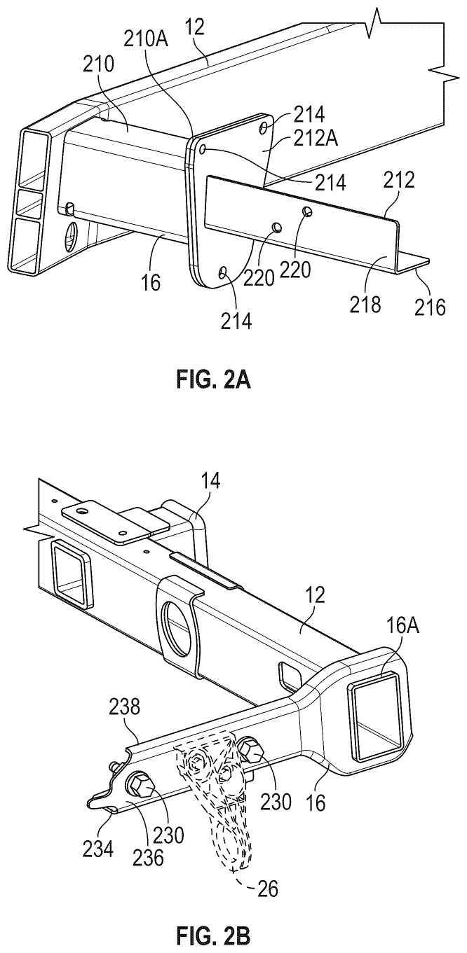

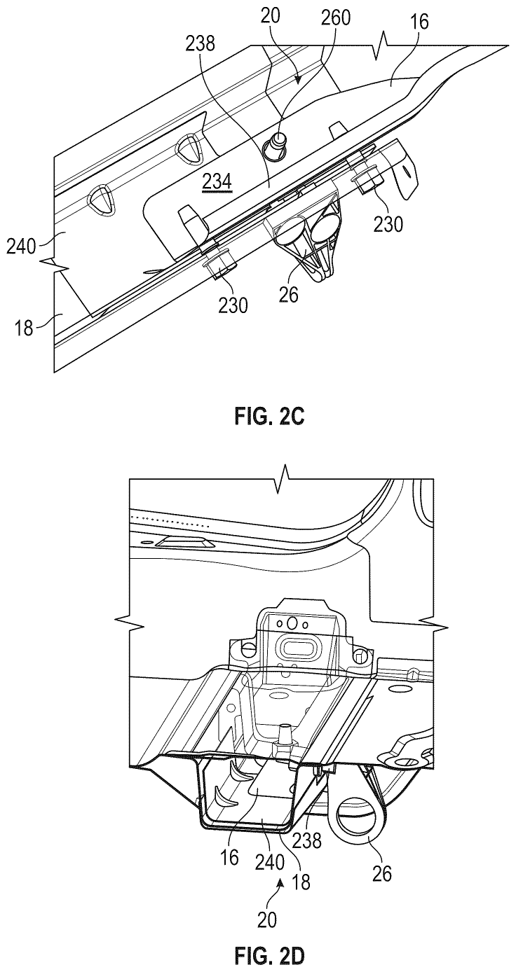

Referring now to FIG. 2A, one example of the bumper mounting bracket 16 is illustrated. In this example, the bumper mounting bracket 16 has a first portion 210 coupled to the bumper cross-member 12. A second member 212 is coupled to the first member 210. A flange 212A, extending from the second member 212, is coupled to a flange 210A coupled to the first member 210. Fasteners may be received through the openings 214 that extend through the flanges 210A and 212A.

The second member 212 is an L-shaped member. The second member 212 has a first wall 216 and a second wall 218, in this example, is perpendicular to the first wall 216. Opening 220 may be used for receiving bolts or other fasteners to support the exhaust hanger 26. The bumper mounting bracket 16 is suitable for an electric vehicle since no openings are formed for coupling to an exhaust hanger.

Referring now to FIG. 2B, another example of the bumper mounting bracket 16 is illustrated. In this example, the exhaust hanger 26 is illustrated in dashed lines to represent the relative position thereof when the bumper interface assembly is assembled. Likewise, the position of fasteners 230 are also illustrated. The fasteners 230 extend through the frame rail, the reinforcement as described later and the bumper mounting bracket 16.

Referring now also FIGS. 2C and 2D, a view of the bumper interface assembly 20 looking from above the vehicle downward is set forth. As is illustrated, the bumper mounting bracket is C-shaped. The bumper mounting bracket 16 includes a first wall 234 that is disposed longitudinally relative to the vehicle. A sidewall 236 extends in a perpendicular direction from the first wall 234. A second wall 238 extends in a perpendicular direction to the sidewall 236 and, in this example, is parallel to the first wall 234.

A reinforcement member 240 is illustrated coupled to the rail 18. As was described earlier, the reinforcement member 240 is C-shaped. The reinforcement member 240 is disposed between the bumper mounting bracket 16 and the rail 18 at least in a portion. Details of the reinforcement member 240 are described below.

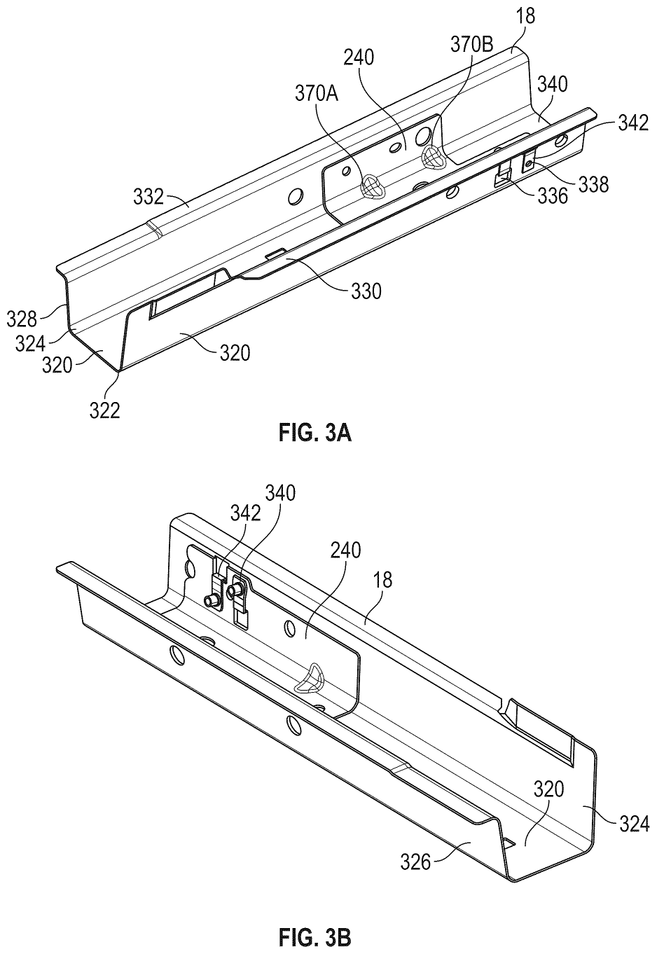

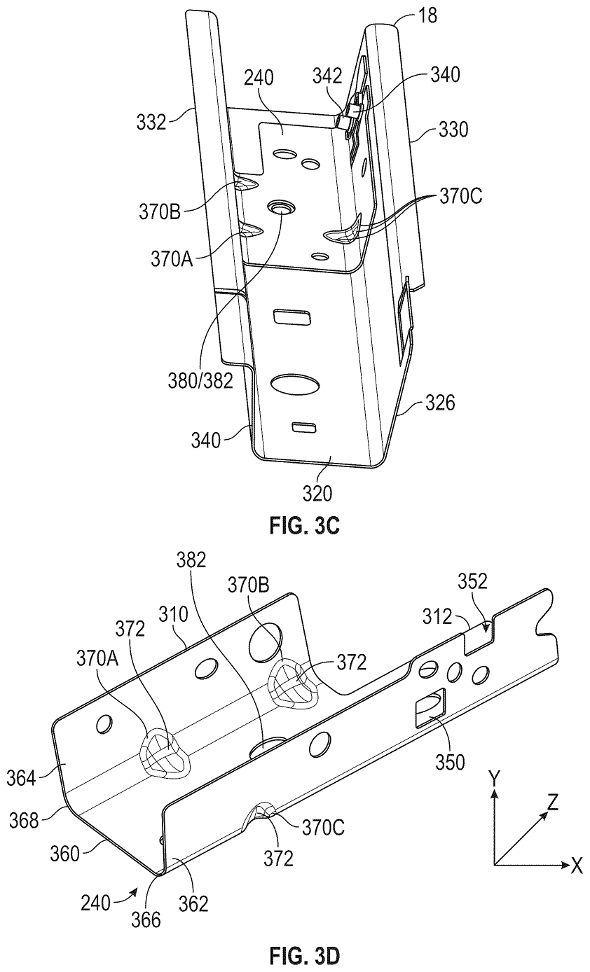

Referring now to FIGS. 3A-3D, details of the frame rail and the reinforcement member 240 are set forth. The reinforcement member 240 is disposed inside the frame rail 18. The frame rail 18, in this example, is generally C-shaped. The reinforcement member 240 has a first portion 310 that is generally C-shaped and a second portion 312 that is generally L-shaped. The first portion 310 and the second portion 312 are a continuous integrally formed structure. The rail 18 has a first wall 320 that has first edge 322 and a second edge 324. The edges 322, 324 extend longitudinally relative to the vehicle. A first sidewall 326 extends generally perpendicular to the first wall 320. A second sidewall 328 extends generally perpendicular from the first wall 320 at the edge 324. Flanges 330 and 332 extend from the sidewalls 326, 328, respectively. The flanges 330 and 332 may extend in a generally perpendicular direction from the sidewalls 326 and 328.

The sidewall 328 may have openings 336 and 338 that are used for receiving a J-nut 340, 342, respectively. The J-nuts 340, 342 are used for supporting the exhaust hanger 26 as illustrated in FIGS. 1A and 1B. In the present example, the J-nuts 340, 342 are rectangular. However, other shapes may be used. The openings 336, 338 may align with openings 350, 352 in the reinforcement member 240. That is, the reinforcement member 240 may have a first wall 360, a second wall 362 and a third wall 364. The openings 350, 352 may be disposed in the second wall 362. Angular edges 366 and 368 may be used to join the first wall 360 and the second wall 362, and the first wall 360 and the third wall 364, respectively. The edges 366 and 368 may extend longitudinally.

The first wall 360 may extend in the first portion 310 and the second portion 312. The third wall 364 may extend and define only the first portion 310 of the reinforcement member 240.

A plurality of darts 370A, 370B and 370C are illustrated. The darts 370A-370C are used for multiple purposes. The darts 370A-370C are used for providing a crash initiator to provide a controlled crumpling. Also, the darts 370A-370C increase the stiffness in both the Y-direction of the vehicle 10 and the torsional stiffness of the reinforcement member which, in turn, is transferred to reinforcing the bumper interface assembly 20. The darts 370A-370C are contoured portions that extend inward from the reinforcement member 240. The darts 370A-370C are discontinuities in the generally uniform surfaces in which they are formed. In the present example, the darts 370A-370C are generally oval in shape and have portions on the first wall 360, the edges 368 or 366 and the second wall 362 or the third wall 364. That is, the dart 370A extends in the third wall 364, the edge 368 and the first wall 360. Likewise, the dart 370B is configured in a similar manner. Both darts 370A and 370B are disposed in the first portion of the reinforcement member 240. The third dart 370C is disposed in the second wall 362, the edge 366 and the first wall 360. Darts 370A-370C have a center portion that is disposed inward from the various mounting walls and form a recess therein.

The rail 18 has an opening 380 aligned with an opening 382 in the reinforcement member 240. The openings 380, 382 allow a fastener 260, as illustrated in FIG. 2C, to extend therein. The fastener 260 may be used to fasten the reinforcement member to the rail 18 and the bumper mounting bracket.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A bumper interface assembly for a vehicle comprising:
a bumper cross-member;
a bumper mounting bracket extending from the bumper cross-member;
a frame member receiving the bumper mounting bracket;
a reinforcement member coupled directly to and within the bumper mounting bracket and disposed between the bumper mounting bracket and the frame member.

2. The bumper interface assembly of claim 1 wherein the cross-member comprises a trailer hitch.

3. The bumper interface assembly of claim 1 wherein the bumper mounting bracket is L-shaped.

4. The bumper interface assembly of claim 1 wherein the bumper mounting bracket is C-shaped.

5. The bumper interface assembly of claim 1 further comprising a first fastener and a second fastener coupled through the bumper mounting bracket, the reinforcement member and the frame member.

6. The bumper interface assembly of claim 1 wherein the frame member comprises a first opening and a second opening.

7. The bumper interface assembly of claim 6 wherein the reinforcement member comprises a third opening aligned with the first opening and a fourth opening aligned with the second opening.

8. The bumper interface assembly of claim 7 further comprising a first J-nut aligned with the first opening and the third opening and a second J-nut aligned with the second opening and the fourth opening.

9. The bumper interface assembly of claim 8 further comprising an exhaust hanger coupled to the first J-nut and the second J-nut.

10. The bumper interface assembly of claim 1 wherein the reinforcement member is C-shaped.

11. The bumper interface assembly of claim 1 wherein the reinforcement member comprises a C-shaped portion and an L-shaped portion.

12. The bumper interface assembly of claim 11 wherein the C-shaped portion comprises a first wall having a first edge and a second edge, a third wall extending from the first edge and a fourth wall extending from the second edge.

13. The bumper interface assembly of claim 12 further comprising a first dart coupled between the first wall, and the second wall.

14. The bumper interface assembly of claim 13 further comprising a second dart coupled between the first wall and the third wall.

15. The bumper interface assembly of claim 14 wherein the first dart and the second dart are disposed in the C-shaped portion.

16. The bumper interface assembly of claim 15 further comprising a third dart coupled between the first wall and the second wall.

17. The bumper interface assembly of claim 16 wherein the third dart is disposed in the C-shaped portion.

18. The bumper interface assembly of claim 1 wherein the reinforcement member is coupled to the frame member with fasteners.

19. A vehicle comprising;
a first bumper interface assembly comprising the bumper interface assembly of claim 1; and
a second bumper interface assembly comping the bumper interface assembly of claim 1.
